(19) United States
(12) Patent Application Publication
(10) Pub. No.: US 2022/0158860 A1
(43) Pub. Date: May 19, 2022

(54) SYSTEMS AND METHODS FOR AUTOMATICALLY PROPOSING MEETING TIME SLOTS BASED ON USER-SPECIFIC FOCUS TIME PREFERENCES

(71) Applicant: MICROSOFT TECHNOLOGY LICENSING, LLC, Redmond, WA (US)

(72) Inventors: Jeff WEST, Sammamish, WA (US); David GROCHOCKI, JR., Seattle, WA (US); Benjamin KELLY, Redmond, WA (US)

(21) Appl. No.: 16/951,959

(22) Filed: Nov. 18, 2020

(51) Int. Cl. H04L 12/18; H04L 29/08

(52) U.S. Cl. CPC H04L 12/1818; H04L 67/306; H04L 12/1822

(57) ABSTRACT

Automatically selecting suitable computing actions to perform with respect to meeting invitations based on user-specific focus time preferences. Individual users customize their own focus time parameters via a graphical user interface that is provided by a computing-implemented calendar system. An individual user may define focus time parameters that prescribes a scheduled focus time that is static in the sense that it occurs at the same time each day and/or a sliding focus duration that can occur within some broader range of time. Flexibility levels may also be prescribed in association with focus time parameters to indicate how flexible or rigid the individual user is with respect to enforcing his or her focus time parameters. The calendar system selects between predefined actions to perform with respect to meeting invitations addressed to the user and that cannot be accepted without resulting in a violation of the user's previously defined focus time parameters.

### BACKGROUND

Under many circumstances, business personnel struggle to balance the competing demands associated with participating in meetings as requested while also dedicating sufficient time to focus on completing deliverable tasks. Exacerbating this struggle is that personal focus time preferences vary greatly from one person to another and there is no one-size-fits-all solution to maximizing productivity. For example, some people may strongly prefer a single four-hour block of focus time during the same time slot each day whereas others may prefer to take breaks between multiple smaller blocks of focus time each day. However, receiving meeting invitations for time slots that are selected without an effort to accommodate invitees' personal focus time preferences all too often results in these invitees having meeting commitments that are scattered in a manner that frustrates their personal focus time preferences.

Calendar systems provide tools for setting up calendar events that reserve blocks of time on invitees' electronic calendars for meetings. Some calendar systems provide a user interface that reveals available and busy times on individual users' electronic calendars for the purpose of assisting a meeting organizer with identifying a time slot where invitees are free to attend. These tools are specifically directed toward facilitating new meeting generation by targeting meeting invitations into time slots at which invitees are not already committed to attend other meetings. While efficient at obtaining commitments to attend new meetings, these tools all too often fragment the free time that remains available to focus on completing deliverable tasks. This is largely because these tools fail to provide meeting organizers with any insight into, or otherwise account for, the invitees' various personal focus time preferences.

It is with respect to these considerations and others that the disclosure made herein is presented.

### SUMMARY

The techniques disclosed herein enable a computer-implemented calendar system to automatically propose meeting time slots that are specifically determined to accommodate user-specific focus time preferences. Generally described, individual users of the calendar system may be presented with a user interface via which each individual users' focus time preferences may be highly customized. For example, an individual user may define a focus time parameter that prescribes a static time slot for daily scheduled focus time. Additionally, or alternatively, the individual user may define a focus time parameter that prescribes a preferred duration of focus time and time range within which time slots of the preferred duration of focus time may slide each day. In some implementations, the individual user may even prescribe flexibility levels in association with focus time parameters to indicate how flexible or rigid the individual user is with respect to enforcing his or her focus time parameters. For example, if a user indicates a high level of flexibility with respect to a particular focus time parameter, the calendar system may subsequently weigh this user-indicated level of flexibility against an indicated level of importance for an incoming meeting invitation to determine an appropriate action to take with respect to the incoming meeting invitation. An exemplary action may be to automatically decline the incoming meeting invitation (i.e., on behalf of the user) based on (i) a requested time slot indicated in the meeting invitation conflicting with the user-specified focus time parameter, and (ii) the weighed importance of the meeting invitation.

In some implementations, the calendar system may automatically respond to the incoming meeting invitation by proposing an alternative time slot to schedule a calendar event (e.g., meeting) which does not conflict with the user-specified focus time parameter. In instances where the incoming meeting invitation is a recurring meeting invitation for generating a series of calendar events at some requested recurrence frequency, the calendar system may determine a proposed frequency modification that is designed to preserve adequate slots of focus time based on individual users' focus time preferences. The proposed frequency modification may indicate a recurrence frequency for a series of meetings and/or adjusted durations and/or adjusted time slots for individual occurrences of the meetings that are determined to defragment the calendars of invitees in a manner that best accommodates previously defined focus time preferences of the individual invitees. As a specific example, if a first subset of invitees has defined focus time parameters indicating a preference for 3 hour slots of focus time in the morning whereas a second subset of invitees has defined focus time parameters indicating a preference for 3 hour slots of focus time in the afternoon, the calendar system may respond to a request for a series of weekly-occurring morning meetings by proposing a series of bi-weekly (e.g., every other week) meeting that are staggered some in the morning and some in the afternoon. In this way, the calendar system may automatically determine a suitable compromise to a requested series of recurring meeting events.

In this way, the techniques described herein enable a calendar system to perform various types of actions with respect to incoming meeting invitations depending on detailed focus time parameters that are highly customized on an individual-user basis. For example, if a user sets up a focus time parameter that defines a scheduled focus time each day and further defines a corresponding flexibility level that prescribes rigid adherence to this scheduled focus time, then the calendar system may automatically decline and/or proposed alternative times for meeting invitations having a requested time slot that falls within the schedule focus time. In some implementations, the calendar system may determine specific actions to perform with respect to an incoming meeting invitation based upon certain characteristics of the incoming meeting invitation in addition to the focus time parameters of invitees on the incoming meeting invitation. For example, under circumstances in which a meeting invitation has a requested time slot that falls within an invitee's schedule focus time, the calendar system may determine an appropriate action to take with respect to the meeting invitation based upon a relationship of the meeting organizer with respect to the invitee within an organizational hierarchy. As a specific but nonlimiting example, a user may set up focus time parameters that cause the calendar system to automatically decline and/or proposed new times for meeting invitations that request calendar time during the scheduled focus time—unless the meeting organizer is the user's manager in which case some alternative action may be performed (e.g., forwarding the meeting invitation to the user's email inbox, automatically accept the meeting invitation, generate a proposed modification to an existing calendar event that would allow for the meeting invitation to be accepted without violating the user's focus time preferences, etc.).

In an exemplary implementation scenario, the computer-implemented calendar system (hereinafter “calendar system”) receives focus time parameters that are uniquely defined in association with a first user account. For example, a user may log into the calendar system via a user device such as a laptop computer by providing credentials associated with the first user account. Then, while logged into the first user account, the user may manually define focus time parameters to be enforced by the calendar system in association with the first user account. For illustrative purposes, presume that the user has logged into the first user account and has prescribed focus time parameters that define a “sliding” preferred focus duration. An exemplary such as “sliding” preferred focus duration may define a time range (e.g., 8:30 AM-2:30 PM), a target (e.g., nominal) duration of focus time (e.g., a nominal duration of three hours), an acceptable duration range (e.g., a minimum duration of 2 hours and a maximum duration of 3.5 hours), and a flexibility level (e.g., a value of 2 on a scale of 1 to 10). By defining her own focus time parameters, the user provides the calendar system with valuable insight into how she prefers to have focus time reserved on her calendar or otherwise made available during a typical day for her to be free from obligations to attend meetings. As described in more detail below, the calendar system then utilizes these focus time parameters to determine appropriate actions to perform with respect to meeting invitations that are addressed to this user (e.g., meeting invitations on which the user is an invitee).

After the user having defined her own unique focus time parameters, the calendar system receives a meeting invitation that is generated by way of a second user account and that is addressed to the first user account (e.g., the user corresponding to the first user account is an invitee on the meeting invitation). The meeting invitation may be configured to facilitate generation of a calendar event on the user's electronic calendar during a requested time slot. For example, the calendar invitation may come in the form of an email communication that includes a user interface element that is selectable to “accept” the meeting invitation, thereby causing a calendar event to be added to the electronic calendar (corresponding to the first user account) during the requested time slot.

Upon receiving the meeting invitation, the calendar system determines whether acceptance of the meeting invitation would result in a violation of the user's focus time parameters. Stated alternatively, the calendar system determines whether adding a new calendar event to the electronic calendar corresponding to the first user account during the requested time slot would violate the user-specific focus time parameters defined in association with the first user account. For example, calendar data corresponding to the first user account may already have one or more already accepted calendar events that render it impossible for the user both accept the meeting invitation while also retaining a block of focus time of her preferred duration (e.g., at least 2.5 hours) during the time range defined within her focus time parameters (e.g., 8:30 AM-2:30 PM).

Then, the calendar system selects between various potential computing actions to perform with respect to the meeting invitation depending on whether acceptance of the meeting invitation would result in the violation of the focus time parameters. As a specific example, responsive to determining that acceptance of the meeting invitation would violate the focus parameters, the calendar system may determine a proposed time slot (e.g., that is alternative to the requested time slot) that a calendar event could be added to the electronic calendar of the user without violating her focus time parameters. In some implementations, the calendar system may automatically decline the meeting invitation on behalf of the user while communicating the proposed time slot to the meeting organizer. Additionally, or alternatively, responsive to determining that acceptance of the meeting invitation would violate the focus time parameters, the calendar system may refrain from forwarding the meeting invitation to the first user account. In this way, the user will not be burdened with the laborious and intensive task of having to manually identify a suitable time to propose in lieu of the requested time slot and furthermore may not even be burdened with the simply distraction of seeing meeting invitations (e.g., in her email) having requested time slots that would frustrate her ability to retain adequate focus time for herself as defined in her unique focus time parameters.

Under the combined circumstances where (i) the meeting invitation is a recurring meeting invitation that is configured to generate a series of calendar events at some requested recurrence frequency during the requested time slot, and (ii) acceptance of the meeting invitation would violate the focus and parameters, the calendar system may automatically determine a proposed recurrence frequency modification on behalf of the invitees. For example, if a recurring meeting invitation is requesting the user to accept a series of weekly one hour long calendar events, the calendar system may identify existing calendar events already on the user's electronic calendar and, based on these existing calendar events, determine that although the recurring meeting invitation cannot be accepted in its current form without violating the focus time parameters, a series of two hour long calendar events can be added to the electronic calendar every other week without violating the focus important.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the figures, the left-most digit(s) of a reference number identifies the figure in which the reference number first appears. The same reference numbers in different figures indicates similar or identical items.

References made to individual items of a plurality of items can use a reference number followed by a parenthetical containing a number of a sequence of numbers to refer to each individual item. Generic references to the items may use the specific reference number without the sequence of numbers. For example, the items may be collectively referred to with the specific reference number preceding a corresponding parenthetical containing a sequence number.

FIG. 1 illustrates an example environment in which a calendar system is configured to select a suitable computing action to perform with respect to meeting invitations based on focus time parameters corresponding to one or more invitees designated by the meeting invitations.

FIG. 2 illustrates an alternative example environment in which the calendar system automatically determines a proposed modification to a recurring meeting invitation to accommodate focus time parameters.

FIG. 3A illustrates an exemplary graphical user (GUI) that is configured to facilitate generation of focus time parameters in accordance with the techniques described herein.

FIG. 3B illustrates an exemplary graphical user (GUI) that is configured to facilitate generation of user-specific focus time flexibility levels for one or more focus time parameters in accordance with the techniques described herein.

FIG. 4 illustrates an alternative example environment in which the calendar system automatically generates meeting invitations based on a preliminary meeting invitation that provides some rudimentary details regarding the characteristics of a desired but yet to be scheduled calendar event.

FIG. 5A illustrates an exemplary graphical user (GUI) that is configured to facilitate generation of a preliminary meeting invitation in accordance with the techniques described herein.

FIG. 5B illustrates another exemplary graphical user (GUI) that is configured to facilitate generation of the preliminary meeting invitation in accordance with the techniques described herein

FIG. 6 is a flow diagram of an example method for selecting actions to perform with respect to incoming meeting invitations based on whether acceptance of the incoming meeting invitations would violate focus parameters associated with a user account.

FIG. 7 shows additional details of an example computer architecture for a computer capable of executing the query scoping service and/or any program components thereof as described herein.

### DETAILED DESCRIPTION

The following Detailed Description discloses technologies for automatically selecting suitable computing actions to perform with respect to meeting invitations based on user-specific focus time preferences. In various embodiments, individual users customize their own focus time parameters via a graphical user interface that is provided by a computing-implemented calendar system. For example, an individual user may define focus time parameters that prescribes a scheduled focus time that is static in the sense that it occurs at the same time each day and/or a sliding focus duration that can occur within some broader range of time. Flexibility levels may also be prescribed in association with focus time parameters to indicate how flexible or rigid the individual user is with respect to enforcing his or her focus time parameters. Then, the calendar system selects between various predefined actions to perform with respect to meeting invitations that are addressed to the user and that cannot be accepted without resulting in a violation of the user's previously defined focus time parameters. The described techniques enable a calendar system to perform actions with respect to incoming meeting invitations that are determined to be appropriate based on detailed focus and user-specific time parameters.

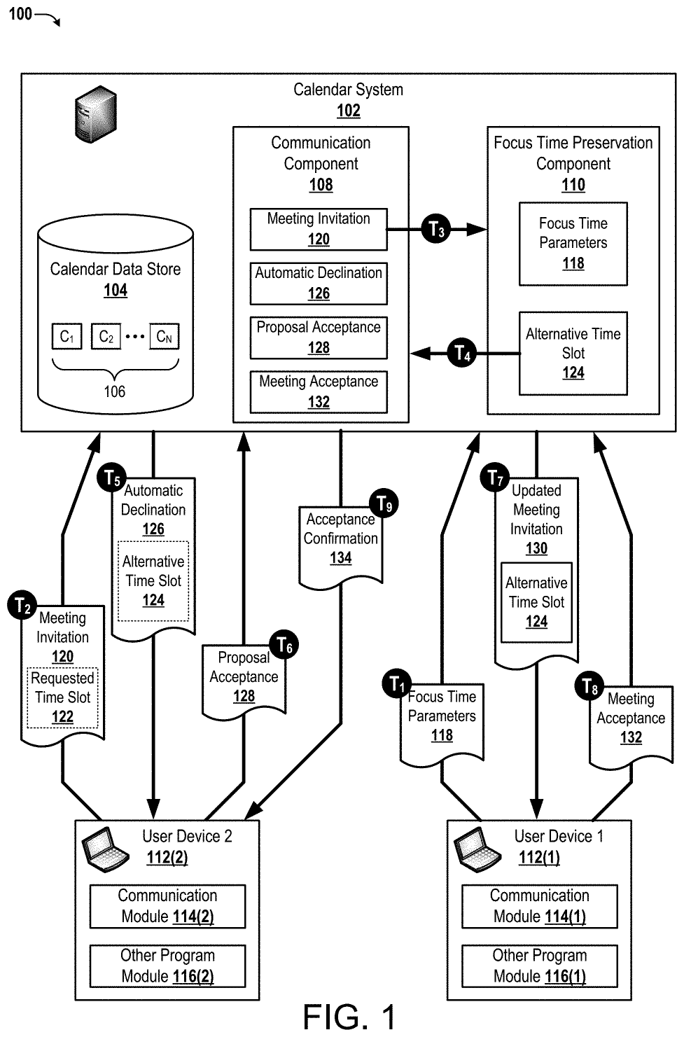

Various examples, scenarios, and aspects of the disclosed techniques are described below with reference to FIGS. 1-7.

FIG. 1 illustrates an example environment 100 in which a calendar system 102 is configured to select a suitable computing action to perform with respect to meeting invitations based on focus time parameters 118 corresponding to one or more invitees designated by the meeting invitations 120. The calendar system 102 maintains a plurality of electronic calendars 106 within a calendar data store 104. Each individual electronic calendar 106 uniquely corresponds to a respective end-user. Each individual electronic calendar 106 facilitates storage of event information that defines aspects of scheduled calendar events. End-users may interact with the calendar system 102 via individual user devices 112 such, for example, user device (1) and user device 112(2). For example, an end-user may provide his or her user credentials to log-into and then access functionalities provided via the calendar system 102. Additionally, or alternatively, administrative-users may interact with the calendar system 102 via user device 112. As used herein, a general reference to a “user,” without a preceding qualifier refers to either an end-user, an administrative-user, or some other individual.

In some use case scenarios, the environment 100 pertains to an organizational setting in which some end-users correspond to members of the organization and other end-users correspond to external entities (e.g., vendors, business partners, suppliers, consultants, etc.) who also interact with the calendar system 102. The calendar system 102 includes (or can be conceptualized as including) various components that perform different functionalities as described herein. Exemplary such calendar systems 102 include, but are not limited to, MICROSOFT OUTLOOK, GOOGLE CALENDAR, or any other suitable electronic calendar software application. Furthermore, exemplary such calendar systems 102 may integrate basic calendaring functionalities with various other productivity-related functionalities such as email functionality, task management functionalities, contact management functionalities, and so on.

An object of the presently disclosed techniques is to enable the calendar system 102 to perform various types of predefined computing actions with respect to incoming meeting invitations for the specific purpose of accommodating (e.g., ensuring minimal violations of) predefined focus time parameters of an individual end-user or of an organization's collective base of end-users. For example, by implementing the disclosed techniques, the calendar system 102 may enforce end-users' individual or collective focus time parameters to ensure that the end-users retain sufficient slots of “focus time” within their electronic calendars 106 which do not violate the end-users' individualized preferences for concentrating during blocks of slotted focus time. For purposes of the present disclosure, a violation of an end-user's focus time parameters refers to occurrences of a predefined length of time (e.g., one morning, one afternoon, one day, one week, etc.) within the end-user's electronic calendar 106 which include one or more scheduled calendar events that prevent the formation of one or more slots of focus time as defined within the focus time parameters 118.

As used herein, the term “focus time” refers to a span of time within an end-user's electronic calendar 106 that is free of scheduled commitments of a predefined type (e.g., calendar events having two or more designed end-user invitees). In an organizational setting, for example, may “focus time” refer to a span of time in which an end-user has no scheduled meetings with other end-users or other fixed organizational commitments that would prevent the user from utilizing this span of time for any purpose he or she deems appropriate. Thus, this span of “focus time” remains available for a corresponding end-user to dedicate a high level of concentration to individual deliverable tasks. The presence of available slots of focus time may be described in either a negative sense, a positive sense, or some combination thereof. For example, in the negative sense a slot of available focus time may refer to a span of time on an end-user's electronic calendar 106 which includes no scheduled events (e.g., the time slot appears empty). In contrast, in the positive sense a slot of available focus time may refer to a span of time on an end-user's electronic calendar 106 includes one or more scheduled events that are designated with a predefined categorical label (e.g., a focus time earmark). Positive designations of such scheduled events with the predefined categorical label may alert the electronic calendar owner and/or other end-users of the designated “focus time” purpose of the corresponding slot of time.

Aspects of an exemplary data flow scenario for utilizing focus time parameters to select a computing action to perform responsive to receiving a meeting invitation are described in relation to FIG. 1 with respect to a first time T₁ through a ninth time T₉. For purposes of the present discussion, these times represent a sequence of times in which: T₁<T₂ . . . <T_{N} (where <means “prior to”). Descriptions of other exemplary data flow scenarios in relation to other figures of the present application may similarly illustrate and refer to specific relative timings of various operations and/or data flows.

At time T₁ of the exemplary data flow scenario, the calendar system 102 receives focus time parameters 118 from a first user device 112(1). For example, a first user may supply user credentials to the calendar system 102 via the first user device 112(1) thereby logging into a first user account. Once logged into the first user account, the first user may define the focus time parameters 118 via a user interface that is specifically configured to facilitate generation of the focus time parameters 118. As described below, these focus time parameters 118 may ultimately be utilized by the calendar system 102 to select between various predefined potential actions to take with respect to incoming meeting invitations. Exemplary actions that can be taken with respect to an individual incoming meeting invitation include, but are not limited to, automatically declining the meeting invitation (e.g., on behalf of an invitee) responsive to a determination that acceptance of the meeting invitation would result in a violation of the invitee's previously defined focus time parameters, forwarding the meeting invitation to the invitee's email inbox responsive to a determination that acceptance of the meeting invitation would not result in a violation of the invitee's previously defined focus time parameters, automatically determining an alternate timeslot during which a calendar event of the specific duration requested within the meeting invitation can be added to the invitee's electronic calendar 106 without resulting in a violation of the invitee's previously defined as time parameters, and so on.

By defining her own focus time parameters 118, the first user provides the calendar system 102 with valuable insight into how she prefers to have focus time reserved on her electronic calendar 106 or otherwise made available during a typical day for her to be free from obligations to attend meetings or other organizational commitments that would prevent her from focusing/concentrating on deliverable tasks. For purposes of FIG. 1, presume that the focus time parameters 118 define a “sliding” preferred focus duration having a time range (e.g., 8:30 AM-2:30 PM) and a minimum duration for “quality” focus time (e.g., a minimum duration of 2 hours).

At time T₂, the calendar system 102 receives a meeting invitation 120 from a second user device 112(2). For example, a second user may supply user credentials to the calendar system 102 via the second user device 112(1) thereby logging into a second user account. Once logged into the second user account, the second user may utilize a calendar functionality provided by the calendar system 102 to address the meeting invitation 120 to the first user account (e.g., designate the first user as an invitee), to define a requested time slot 122, and to define various other aspects of the meeting invitation such as a title and/or importance level. For purposes of FIG. 1, presume that the requested time slot 122 is 12:30 PM-1:00 PM.

At time T₃, a communication component 108 of the calendar system 102 provides the meeting invitation 120 (or at least some information about the meeting invitation 120) to a focus time preservation component 110. The communication component 108 provides a mechanism for end-users to communicate with one another regarding the scheduling (e.g., adding, cancelling, rearranging, etc.) of calendar events within the electronic calendars 106. For example, the communication component 108 may expose a calendar event creation user interface to the second user via a communication module 114(2) on the second user device 112(2). The calendar event creation user interface may enable the second user to generate and transmit the meeting invitation 120 to one or more other users. The communication component 108 may be configured to transmit individual meeting invitations to the user accounts that are designated as required and/or optional invitees therein.

The focus time preservation component 110 provides a mechanism for analyzing aspects of incoming meeting invitations 120 with respect to both the calendar data store 104 and the focus time parameters 118 so as to enable the calendar system 102 to enforce end-users' focus time parameters 118. For purposes of FIG. 1, presume that the calendar data store 104 includes an electronic calendar 106 that belongs to the first user and that includes scheduled calendar events from 8:30 AM-11:30 AM, a continuous slot of unreserved (e.g., “open” or “free”) calendar time from 11:30 AM-2:30 PM having no scheduled calendar events, additional scheduled calendar events from 2:30 PM-4:00 PM, and another continuous slot of unreserved calendar time from 4:00 PM-5:30 PM. Accordingly, based on the current state of the first user's electronic calendar 106, the focus time preservation component 110 determines that the meeting invitation 120 cannot be accepted as received because the addition of a new calendar event into the requested time slot 122 of 12:30 PM-1:00 PM would prevent the first user from having at least one continuous 2-hour slot of time available for use as “focus time” within the time range from 8:30 AM-2:30 PM. Stated alternatively, acceptance of the meeting invitation 120 would result in a violation of the focus time parameters 118 corresponding to the first user account.

At time T₄, the focus time preservation component 110 determines an alternative time slot 124 during which a calendar event of the same duration as the requested time slot 122 can be added to the first user's electronic calendar 106 without violating the focus time parameters 118. For example, since the electronic calendar 106 that belongs to the first user includes a continuous slot of unreserved calendar time from 4:00 PM-5:30 PM, the focus time preservation component 110 may identify the time slot from 4:15 PM-5:15 PM as the alternative time slot 124. Here, automatically determining the alternative time slot on behalf of the first user represents an exemplary action that can be taken with respect to a meeting invitation 120.

At time T₅, the calendar system 102 responds to the meeting invitation 120 on behalf of the first user by transmitting an automatic declination 126 to the second user account. As illustrated, the automatic declination 126 may include the alternative time slot 124 as a proposal for updating the meeting invitation 120 in a manner that fully accommodates the first user's focus time parameters 118. In some embodiments, the automatic declination 126 may be designed to communicate a reason as to why the meeting invitation 120 has been declined (e.g., a message that reads “This meeting invitation is being respectfully declined on behalf of ‘Invitee Name’ based on her preference of having a daily 2 hour continuous block of focus time between 8:30 AM-2:30 PM. Although the originally requested time slot cannot be accommodated due to existing calendar events, the time slot of 4:15 PM-5:15 PM is proposed as an alternative. Is this alternative time acceptable?”

At time T₆, the calendar system 102 receives a proposal acceptance 128 from the second user device 112(2). That is, the calendar system 102 receives a communication from the second user device 112(2) that indicates that the alternative time slot 124 have been accepted by the second user (e.g., the meeting organizer in this example).

At time T₇, an updated meeting invitation 130 is transmitted from the calendar system 102 to the first user device 112(1). As illustrated, the updated meeting invitation 130 includes an indication of the alternative time slot 124 that has been automatically determined by the focus time preservation component 110 on behalf of the first user. It is worth noting that in the exemplary data flow scenario described in relation to FIG. 1, the calendar system 102 has performs multiple actions automatically on behalf of the first user based on the determination that the meeting invitation 120 cannot be accepted in original form without resulting in a violation of the first user's focus time parameters. 118. First, the calendar system 102 automatically determines an alternative time slot (i.e., alternative to the originally requested time slot) during which a calendar event of the requested duration (e.g., 1 hour) can be scheduled without violating the first user's focus time parameters 118. Second, the calendar system 102 automatically replies to the meeting invitation 120 on the first user's behalf to decline the meeting invitation 120 while also proposing the alternative time slot. Third, the calendar system 102 refrains from the “original” meeting invitation 120 to the first user account but rather waits to transmit the updated meeting invitation 130 once the details regarding a suitable time slot for the meeting have been worked out between the calendar system 102 and the second user. In this way, the first user is not bothered with receiving the “original” meeting invitation 120 which cannot be accepted without violating her personalized focus time goals.

At time T₈, the calendar system 102 receives a meeting acceptance 132 from the first user device 112(1). For example, the first user may view the updated meeting invitation 130 via the first communications module 114(1) (e.g., an email application that presents aspects of the updated meeting invitation 130 in message form). Then, while viewing the updated meeting invitation 130, the first user may provide some form of user input (e.g., selecting a “accept” button) to indicate an acceptance of the updated meeting invitation 130.

At time T₉, the calendar system 102 transmits an acceptance confirmation 134 to the second user device 112(2) to provide the second user with confirmation that the first user has accepted the updated meeting invitation 130. Ultimately, the calendar system 102 may add a new calendar event to the first user's electronic calendar 106 based on the combination of the proposal acceptance 128 and the meeting acceptance 132.

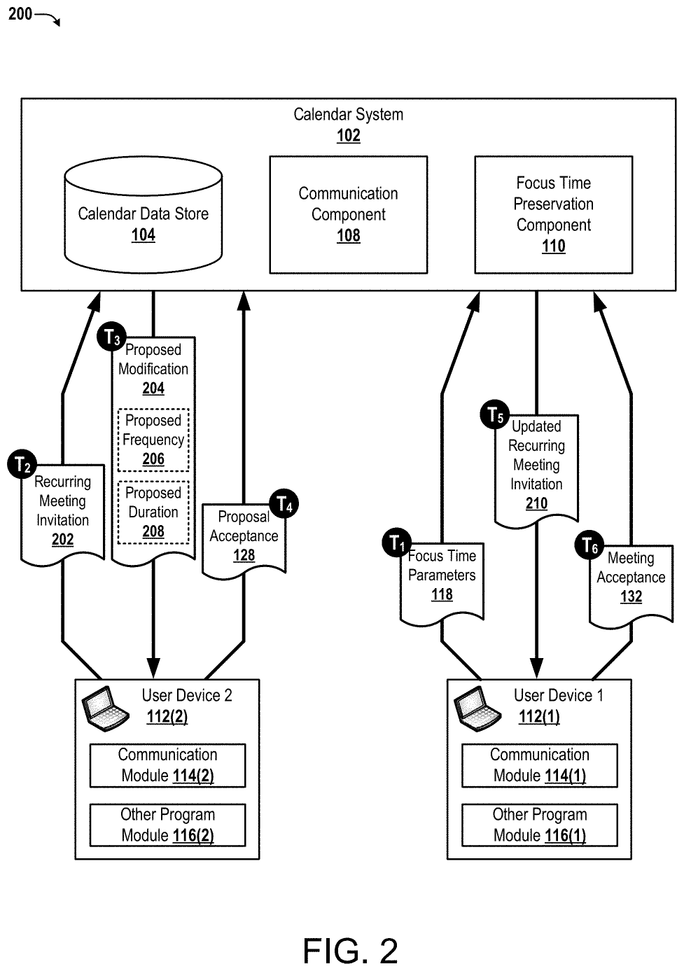

FIG. 2 illustrates an alternative example environment 200 in which the calendar system 102 automatically determines a proposed modification to a recurring meeting invitation 202 to accommodate focus time parameters 118. As used herein, the term “recurring meeting invitation” refers to an electronic communication that is configured to generate a series of calendar events within one or more electronic calendars 106 at a requested recurrence frequency for at least some duration of time. An exemplary recurring meeting invitation may be configured to generate a series of one-hour long calendar events from 9:00 AM to 10:00 AM each Monday in perpetuity. Another exemplary recurring meeting invitation may be configured to generate a series of one-hour long calendar events at the same time each Monday and Wednesday for a duration of 10-weeks.

At time T₁, the calendar system 102 receives focus time parameters 118 in association with a first user account that corresponds to a first user. As illustrated, the focus time parameters 118 are received from a first user device 112(1). For example, as described above, the first user may log into her account and manually define the focus time parameters 118 an behalf of herself. Additionally, or alternatively, an administrative-user may log into an administrative user account associated with the calendar system 102 to generate focus time parameters 118 on behalf of one or more end-users. For purposes of FIG. 2, presume that the focus time parameters 118 define a “sliding” preferred focus duration having a time range (e.g., 8:30 AM-2:30 PM) and a minimum duration for “quality” focus time (e.g., a minimum duration of 2 hours).

At time T₂, the calendar system 102 receives a recurring meeting invitation 202 from a second user device 112(2). The recurring meeting invitation 202 indicates a requested recurrence frequency and is configured to facilitate generation of a series of calendar events within one or more electronic calendars 106 that are spaced apart in time based on the requested recurrence frequency. For purposes of FIG. 2, presume that the recurring meeting invitation 202 is configured to generate a series of meetings from 10:00 AM-11:00 AM on Mondays every week in perpetuity. Thus, the recurring meeting invitation 202 can be aptly characterized as having a requested recurrence frequency of 1-week and a requested meeting duration of 1-hour.

After receiving the recurring meeting invitation 202, the calendar system 102 determines whether the recurring meeting invitation 202 can be accepted by the first user without violating the focus time parameters 118. For example, the calendar system 102 may access the first user's electronic calendar 106 from the calendar data store 104 to determine whether or not adding the requested series of new calendar events from 10:00 AM-11:00 AM on Mondays every week in perpetuity will violate the focus time parameters 118 due to other already existing calendar events within the first user's electronic calendar 106. For purposes of FIG. 2, presume that the calendar system 102 determines that adding the requested series of new calendar events would violate the focus time parameters 118. Further presume that the calendar system 102 also determines that adding a series of new calendar events from 9:00 AM-11:00 AM on Mondays every other week will not violate the focus time parameters 118. Under these circumstances, the calendar system 102 has determined both of: (i) a proposed recurrence frequency modification for generating the series of calendar events in the electronic calendar without violating the focus time parameters 118, and (ii) a proposed meeting duration modification for maintaining a constant aggregate meeting duration. That is, meeting for one hour each week will yield the same aggregate meeting time/duration as meeting for two hours every other week.

In various implementations, the calendar system 102 may utilize machine learning and/or artificial intelligence techniques to determine aspects of proposed meeting duration modification and/or proposed meeting modification for accommodating focus time parameters 118. For example, the calendar system 102 may observe aspects of how the first user specifically and/or a larger collection of end-users typically schedule recurring meetings. As a specific example, the calendar system 102 may determine the first user typically does not receive recurring meeting invitations and/or does not accept recurring meeting invitations having a recurrence frequency of greater than the particular period of time (e.g., two weeks, three weeks, etc.). As another specific example, the calendar system 102 may analyze aspects of the recurring meeting invitation 202 to determine one or more relevant characteristics such as, for example, a meeting organizer and/or other invitees designated on the recurring meeting invitation 202. Then, the calendar system 102 may determine a proposed modification 204 to the recurring meeting invitation 202 based upon relevant characteristics of the recurring meeting invitation 202 as originally submitted. To illustrate this point, the calendar system 102 may identify that the first user already has one or more scheduled calendar events in common with a second user that sent the recurring meeting invitation 202. Then, the calendar system 102 may generate proposed modification 204 in a manner that places the newly requested series of meetings temporally adjacent to the one or more scheduled calendar events the first user already has in common with the second user.

At time T₃, the calendar system 102 response to the recurring meeting invitation 202 by transmitting a proposed modification 204 back to the second user account. For example, as illustrated, the calendar system 102 transmits the proposed modification 204 back to the second user device 112(2) from which the recurring meeting invitation 202 was received. In some embodiments, the proposed modification 204 may include the proposed meeting frequency modification 206. Additionally, or alternatively, the proposed modification 204 may include the proposed duration modification 208.

In some embodiments, the calendar system 102 may determine aspects of the proposed modification 204 in a manner that optimizes the calendar of the first user. For example, the calendar system 102 may analyze the first user's existing calendar appointments with respect to the first user's focus time parameters and, based thereon, may determine the proposed frequency 206 so as to defragment the first user's calendar. Additionally, or alternative, the calendar system 102 may determine aspects of the proposed modification 204 in a manner that optimizes the calendars of some combination of users designated as invitees on the recurring meeting invitation 202. For example, the calendar system 102 may analyze the calendars of all of the invitees or some prioritized subset of the invitees and determine the proposed frequency 206 in a manner that accommodates the relevant invitees' (e.g., all invites or the prioritized subset of invitees) focus time parameters.

In some embodiments, the calendar system 102 may utilize an artificial intelligence (AI) model to determine aspects of the proposed modification 204 based on various factors such as, for example, past patterns of meetings associated with one or more invitees, indications of meeting importance provides within the meeting invitations, indications of user interest in certain topics, and so on. An exemplary AI model can utilize various technologies to identify characteristics of meetings that invitees have typically accepted, declined, and/or proposed an alternative time for. For example, and without limitation, the AI model can utilize unsupervised clustering, Bayesian networks, representation learning, similarity and metric learning, rule-based machine learning, learning classifier systems, support vector machines (“SVMs”), deep learning, artificial neural networks, associated rule learning, decision tree learning, or other machine learning techniques.

In some embodiments, the calendar system 102 may monitor user behavior in association with scheduling of calendar events to generate user-specific calendar scheduling models. Then, the calendar system 102 may utilize these user-specific calendar scheduling models to select appropriate actions to take in response to meeting invitations. In some embodiments, the calendar system 102 may deploy individual user-specific calendar scheduling models with respect to individual user accounts. For example, the calendar system 102 may observe user activity in association with the first user account over a suitable period of time to “learn” how the first user typically will respond to meeting invitations having certain characteristics. As a specific but non-limiting example, the calendar system 102 may utilize user activity occurring in association with the first user account over a period of several months as training data within a suitable machine learning algorithm. Under these circumstances, utilizing the “user activity” training data as an input to the machine learning algorithm may reveal that over a period of several months the first user has proposed alternative times to meeting invitations that have been received from external vendors each time these meeting invitations have requested meeting times that would violate the first user's focus time parameters. Accordingly, the user specific calendar scheduling model that is built by the calendar system 102 in association with the first user may be configured to cause the calendar system to automatically decline and propose alternative times for any meeting invitations that are received from external vendors at the first user account. At the same time, utilizing the “user activity” training data as an input to the machine learning algorithm may further reveal that over the same period of several months the first user has accepted meeting invitations (without proposing alternative times) that have been received from a particular internal user account (e.g., the first user's manager). Accordingly, the same user specific calendar scheduling model that causes the automatic declinations responsive to meeting invitations received from external vendors will automatically accept and/or simply allowed to pass through to the user's email inbox any meeting invitations that are received from the particular internal user account.

In some embodiments, the calendar system 102 may build user specific calendar scheduling models for a plurality of user accounts and may utilize multiple user specific calendar scheduling models for determining appropriate actions to take with respect to received meeting invitations. For example, under circumstances in which a meeting invitation is received by the calendar system 102 and designates four different invitees for which user specific calendar scheduling models have been created, the calendar system 102 may utilize each of these four different users' calendar scheduling models in combination to select a suitable action to take with respect to the meeting invitation. As a specific but nonlimiting example, the combination of the four different calendar scheduling models that have been built for the different individual user accounts may reveal that three of the four user accounts have typically responded to past meeting invitations having similar characteristics to adjust received meeting invitation by proposing alternative times that are very early in the morning whereas the one remaining user account is typically accepted the such meeting invitations. Under these circumstances, the calendar system 102 may automatically respond to the just received meeting invitation by proposing an alternative time that is very early in the morning since the majority of users designated as invitees have done so in the past.

At time T₄, the calendar system 102 receives a proposal acceptance 128 from the second user device 112(2). That is, the calendar system 102 receives a communication from the second user device 112(2) that indicates that the proposed modification 204 have been accepted by the second user.

At time T₅, an updated recurring meeting invitation 210 is transmitted from the calendar system 102 to the first user device 112(1). The updated recurring meeting invitation 210 may include one or both of the proposed frequency modification 206, proposed duration modification 208, and/or an indication that the second user has already accepted the proposed modification 204 via proposal acceptance 128.

At time T₆, the calendar system 102 receives a meeting acceptance 132 from the first user device 112(1). For example, the first user may view the updated recurring meeting invitation 210 via the first communications module 114(1) (e.g., an email application that presents aspects of the updated meeting invitation 130 in message form). Then, while viewing the updated recurring meeting invitation 210, the first user may provide some form of user input (e.g., selecting a “accept” button) to indicate an acceptance of the updated meeting invitation 130. The calendar system 102 may add a new calendar event to the first user's electronic calendar 106 based on the combination of the proposal acceptance 128 and the meeting acceptance 132.

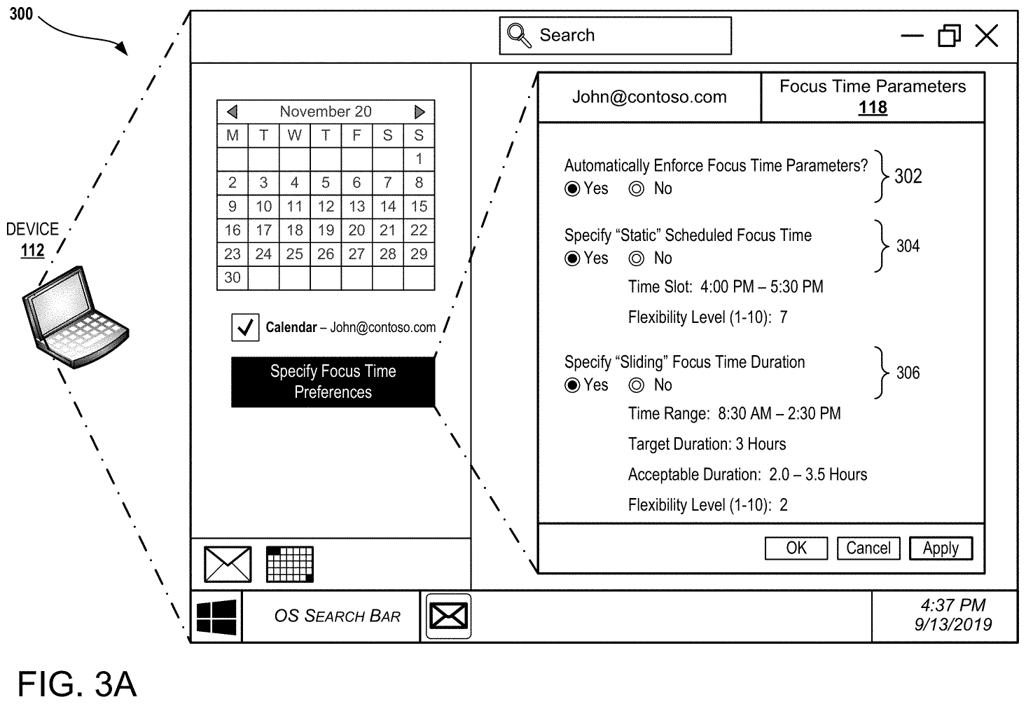

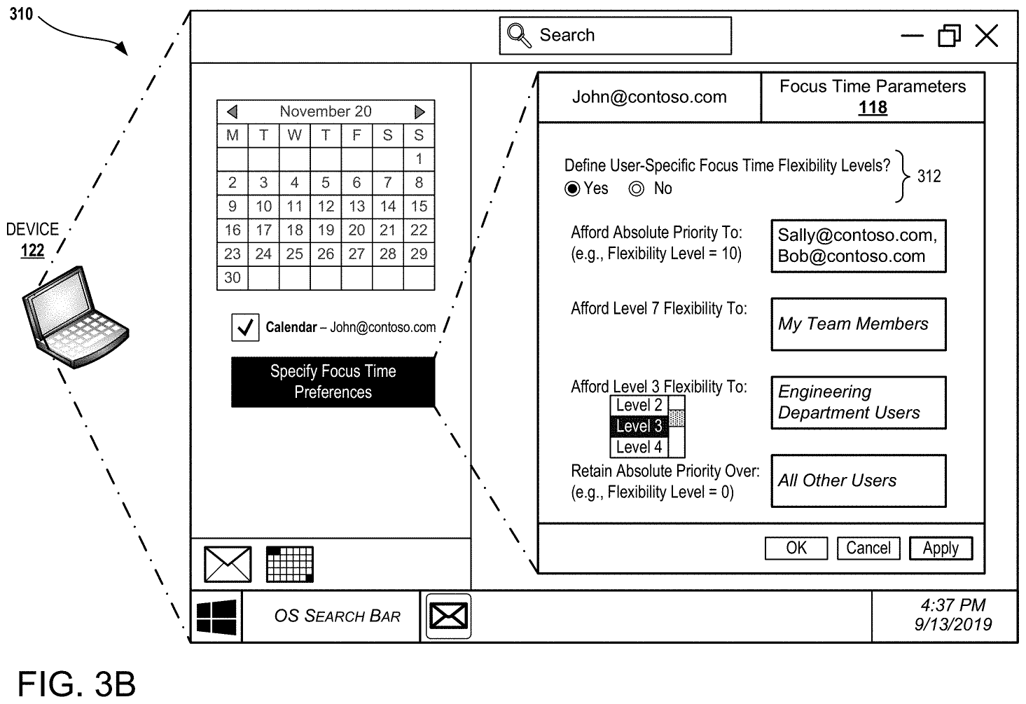

Turning now to FIG. 3A, illustrated is an exemplary graphical user (GUI) 300 that is configured to facilitate generation of focus time parameters 118 in accordance with the techniques described herein. Here, the GUI 300 is illustrated within the context of a being integrated within or native to a calendaring software application such as MICROSOFT OUTLOOK.

As illustrated, the GUI 300 includes a first user interface element 302 that enables a user to prescribe whether the calendar system 102 is to automatically enforce the focus time parameters 118 in association with a specific user account (e.g., John@contoso.com). Automatic enforcement of the focus time parameters 118 may include performing various actions on behalf of a user without requiring user input or instructions from the user as a condition precedent to performing the various actions. For example, automatic enforcement may include automatically declining and/or automatically proposing modifications to meeting invitations which cannot be accepted without violating the focus time parameters 118 defined for a specific user account. Under circumstances in which the first user interface element 302 is toggled to prescribe that the calendar system 102 in not to automatically enforce the focus time parameters 118, then the calendar system 102 may determine proposed actions to take in response to receiving meeting invitations that cannot be accepted without violating the focus time parameters 118 and may then present these proposed actions to the affected users (e.g., John@contoso.com).

The GUI 300 further includes a second user interface element 304 that enables the user to define a focus time parameter associated with reserving a specific time slot for focus time each business day. As illustrated, this focus time parameter defines the specific time slot of 4:00 PM-5:30 PM.

In some embodiments, the GUI 300 further enables the user to prescribe specific flexibility levels associated with individual focus time parameters. In general terms, the flexibility levels prescribed in association with a focus time parameter serves to indicate how flexible or rigid the individual user is with respect to enforcing this particular focus time parameter. For example, if a user indicates a high level of flexibility with respect to a particular focus time parameter, the calendar system may subsequently weigh this user-indicated level of flexibility against an indicated level of importance for an incoming meeting invitation to determine an appropriate action to take with respect to the incoming meeting invitation. An exemplary action may be to automatically decline the incoming meeting invitation (i.e., on behalf of the user) based on (i) a requested time slot indicated in the meeting invitation conflicting with the user-specified focus time parameter, and (ii) the indicated importance of the meeting invitation outweighing the indicated level of flexibility. For example, an incoming meeting that is flagged as being “High Importance” or “Urgent” may not trigger an automatic declination 126 if the flexibility level for a violated focus time parameter is 7 whereas another incoming meeting that is similarly flagged as being “High Importance” or “Urgent” may trigger an automatic declination 126 if the flexibility level for a violated focus time parameter is only 2. Here, the flexibility level of 2 indicates a highly level of rigidity (or relative inflexibility) whereas the flexibility level of 7 indicates a high level of flexibility.

The GUI 300 further includes a third user interface element 306 that enables the user to define a focus time parameter associated with placing a time slot of some nominal or preferred duration within a larger user specified time range. As illustrated, this focus time parameter defines a time range of 8:30 AM-2:30 PM, a target (e.g., nominal) duration of 3 hours for focus time, an acceptable duration range bound by a minimum duration of 2 hours and a maximum duration of 3.5 hours, and a flexibility level of 2 (e.g., a scale of 1 to 10).

Turning now to FIG. 3B, illustrated is an exemplary graphical user (GUI) 310 that is configured to facilitate generation of user-specific focus time flexibility levels for one or more focus time parameters 118 in accordance with the techniques described herein. As used herein, the term “user-specific focus time flexibility levels” refers to indicated levels of flexibility associated with one or more focus time parameters that are contingently applied to select an appropriate computing action depending on specific users that are associated with (e.g., organizers of, invitees of, etc.) a meeting invitation.

In the illustrated example, a user interface element 312 has been selected that indicates an intention or desire of a user to prescribe user-specific focus time flexibility levels for one or more focus time parameters 118. As shown, user input has been provided that indicates that absolute priority is to be afforded to two specifically defined users (e.g., Sally@contoso.com and Bob@contoso.com). In some implementations, absolute priority being afforded to a user (or group of users) serves as an indication to the calendar system 102 regarding what actions to perform (or refrain from performing) with respect to meeting invitations that are associated with the user (or group of users) in a particular manner. For example, absolute priority being afforded to Bob@contoso.com may cause the calendar system 102 to refrain from automatically declining and/or proposing alternative times for meeting invitations on which Bob@contoso.com is a meeting organizer and/or invitee.

In contrast, absolute priority retained over a user (or group of users) may serve as an indication to the calendar system 102 regarding alternative actions to perform (or refrain from performing) with respect to meeting invitations that are associated with the user (or group of users) in a particular manner. For example, absolute priority retained over “All Other Users” may cause the calendar system 102 to automatically decline and/or propose alternative times for meeting invitations that are not associated with any users not identified with respect to other specifically defined user-specific focus time flexibility levels.

In some embodiments, individual user-specific focus time flexibility levels may be defined in relation to an organizational hierarchy. For example, as illustrated, the user input that has been provided via the GUI 310 indicates that a flexibility level of 7 is to be afforded to users that are designated within an organizational hierarchy as being team members of John@contoso.com.

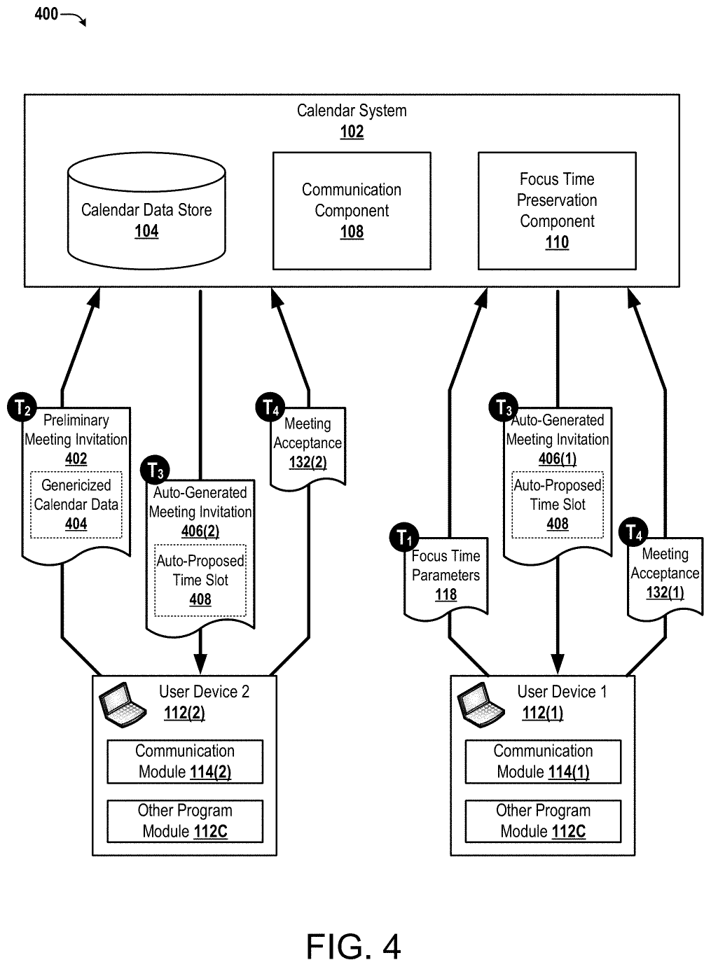

FIG. 4 illustrates an alternative example environment 400 in which the calendar system 102 automatically generates meeting invitations based on a preliminary meeting invitation 402 that provides some rudimentary details regarding the characteristics of a desired but yet to be scheduled calendar event. Similar to example environments 100 and 200, at time T₁ the calendar system 102 receives focus time parameters 118 from a first user device 112(1). Although not specifically illustrated, in various implementations of example environment 400 (and example environment 100 and/or 200 for that matter) the calendar system 102 may also receive additional focus parameters corresponding to the second user account. In such implementations, the calendar system 102 may determine proposals for setting up calendar events that will accommodate focus time parameters 118 corresponding to multiple different user accounts that are designated as invitees and/or meeting organizers for a particular calendar event.

At time T₂, the calendar system 102 receives the preliminary meeting invitation 402 that describes details regarding the characteristics of a desired but yet to be scheduled calendar event. Exemplary such details include, but are not limited to, an invitee list associated with the calendar event, an acceptable time range (e.g., mornings, afternoons, a range of days, etc.) within which scheduling of the calendar event is desired, an urgency level of the calendar event, a desired duration of the calendar event, recurrence details (if appliable), and so on.

In some implementations, the preliminary meeting invitation 402 may further include genericized calendar data 404 associated with the meeting organizer and/or one or more invitees. With respect to this point, it can be appreciated that some existing calendar systems provide the ability for internal users to access or view some aspects other internal users calendars. For example, two different users that are members of the same organization (e.g., company) may be able to see calendar events on each other's electronic calendars 106—which may be useful tool for sending meeting invitations that do not conflict with other already scheduled meetings. However, in some circumstances, the calendar system 102 may not have access to electronic calendars for one or more meeting organizers and/or invitees associated with a yet to be scheduled calendar event. In the illustrated example 400 environment, providing the genericized calendar data 404 along with the preliminary meeting invitation 402 serves to provide the calendar system 102 with information suitable for determining how a calendar event could potentially be scheduled without conflicting with calendar events already scheduled on electronic calendars which the calendar system 102 lack access or visibility to. For purposes of FIG. 4, presume that the second user is an external user (e.g., a vendor to) and the first user is an internal user (e.g., an employee of) the organization for which the calendar system 102 is being implemented.

Here, the genericized calendar data 404 is genericized in the sense the some information has been removed from the calendar data of the second user whereas other information that defines at least some slots of available time on the second user's calendar remain. In this way, the calendar system 102 gains some insight into when a calendar event could be scheduled without conflicting the prior commitments already on the second user's calendar. At the same time, aspects of information that the second user would not wish to share with the organization remain confidential therefrom.

Upon receiving the preliminary meeting invitation 402, the calendar system 102 generates an auto-generated meeting invitation 406 that includes an auto-proposed time slot 408. In some embodiments, the calendar system 102 determines the auto-proposed time slot 408 based on requisite details for the yet to be scheduled calendar event that are defined within the preliminary meeting invitation 402 and the electronic calendar(s) associated with end-users that are designated (within the preliminary meeting invitation 402) as invitees of the yet to be scheduled calendar event. Additionally, or alternatively, the calendar system 102 may determine the auto-proposed time slot 408 so as to accommodate the invitees' focus time parameters 118. Furthermore, in implementations such as illustrated in which the calendar system 102 receives the genericized calendar data 404, the calendar system 102 may determine the auto-proposed time slot 408 so as to avoid conflict with any existing calendar events indicated within the genericized calendar data 404.

At time T₃, the calendar system 102 transmits respective instances of an auto-generated calendar invitation 406 to invitees designated within and/or a meeting organizer that generated the preliminary meeting invitation 402. For example, as illustrated, a first instance of the auto-generated calendar invitation 406(1) is transmitted to the first user device 112(1) and a second instance of the auto-generated calendar invitation 406(2) is transmitted to the second user device 112(2). In this way, a meeting organizer (e.g., the second user in this example) is provided with an ability to outline requisite parameters for a desired meeting via the preliminary meeting invitation 402. Then, rather than the meeting organizer actually selecting an fully defined proposed time slot and sending out a meeting invitation to all invitees (only to have one or more invitees decline the meeting invitation due to unforeseen scheduling conflicts), the calendar system 102 determines a suitable time slot based on the invitees calendars and focus parameters and sends out auto-generated meeting invitations 406 to the meeting organizer and invitees. As illustrated, at time T₄ meeting acceptances are received from the first user and second user.

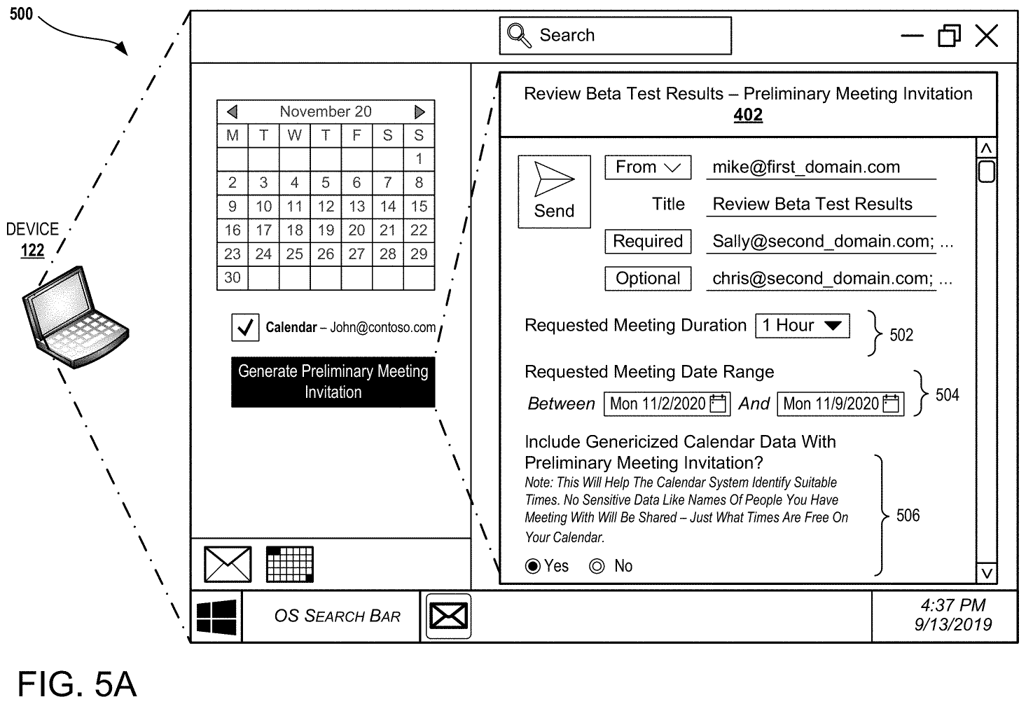

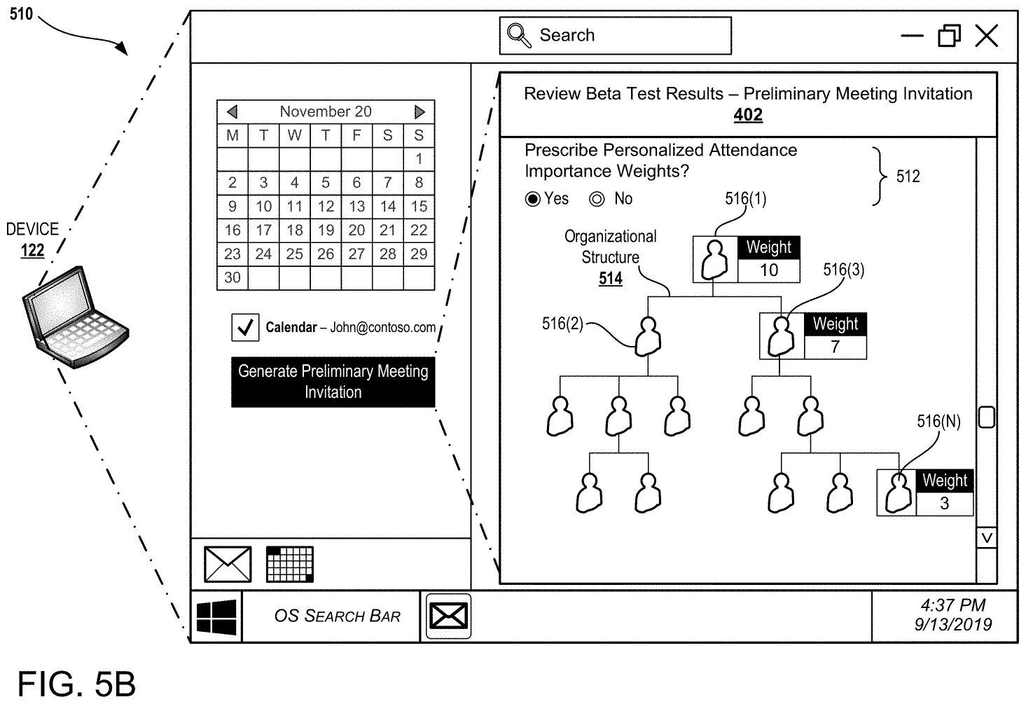

Turning now to FIG. 5A, illustrated is an exemplary graphical user (GUI) 500 that is configured to facilitate generation of a preliminary meeting invitation 402 in accordance with the techniques described herein. Here, the GUI 500 is illustrated within the context of a being integrated within or native to a calendaring software application such as, for example, MICROSOFT OUTLOOK which provides calendaring functionality for managing (e.g., generating invitations for, creating, accepting, declining, proposing modifications to, etc.) calendar events.

As illustrated, the GUI 500 includes user interface elements (e.g., input fields) that enable a user to indicate a title for and various end-user accounts associated with a yet to be scheduled calendar event. Specifically, in the illustrated example, user input has been provided to prescribe a title of “Review Beta Test Results” for the calendar event. Furthermore, user input has been provided to indicate a meeting organizer in the “From” field (i.e., mike@first_domain.com), one or more required attendees in the “Required” field (i.e., Sally@second_domain.com), and one or more optional attendees in the “Optional” field (i.e., Chris@second_domain.com).

The GUI 500 includes a user input field 502 that enables a user to specify a requested meeting duration for the yet to be scheduled calendar event. For example, as shown in FIG. 5A the meeting organizer has used the user input field 502 to specify that the requested meeting duration corresponding to the preliminary meeting invitation 402 is 1-Hour. The GUI 500 further includes a user input field 504 that enables the user to specify a requested meeting date range. As shown, the meeting organizer has used the input field 504 to specify that the requested meeting date range is between Monday Nov. 2, 2020 and Monday Nov. 9, 2020. Accordingly, upon receiving the preliminary meeting invitation 402 as described in FIG. 4, the calendar system 102 may determine a suitable 1-hour time slot on or between the user specified dates that does not violate the focus parameters 118 for one or more users specified in the preliminary meeting invitation 402 (e.g., invitees) and does not conflict with any existing calendar events that are included within the electronic calendars 106 for the one or more specified users.

The GUI 500 further includes a user input field 506 that enables the user to specify whether to include genericized calendar data 404 (or non-genericized “standard” calendar data for that matter) within the preliminary meeting invitation 402. As illustrated, the user has provided input to opt into providing the genericized calendar data 404. The functionalities described herein in relation to sharing genericized calendar data 404 can employ various mechanisms to ensure that any user data is handled in a manner that conforms to applicable laws, social norms, and the expectations and preferences of individual users. For example, as illustrated in FIG. 5A, the user input field 506 allows the user to expressly opt in to (and then expressly opt out of) the provisions of the functionality for sharing aspects of his or her calendar data. The functionality can also provide suitable security mechanisms to ensure the privacy of the user data (such as data—sanitizing mechanisms, encryption mechanisms, password—protection mechanisms, etc.).

Turning now to FIG. 5B, illustrated is another exemplary graphical user (GUI) 510 that is configured to facilitate generation of the preliminary meeting invitation 402 in accordance with the techniques described herein. Here, the GUI 510 is illustrated as an extension of the GUI 500 in the sense that the user has simply scrolled down from the GUI 500 to reveal the aspects of the GUI 510. Upon scrolling down (e.g., via the scroll user interface element on the right side of the GUIs 500 and 510), a user interface element 512 is revealed that enables the user to prescribe personalized attendance importance weights on a user-by-user basis. As illustrated, the GUI 510 includes a graphical representation 514 of an organizational structure corresponding to an enterprise implementing the calendar system 102. Here, the graphical representation 514 is shown in the form of an organizational hierarchy of end-users within the enterprise. For example, the organizational hierarchy the organizational hierarchy may represent, for example, a reporting structure indicating reporting relationships between individual end-users. For purposes of the present discussion, presume that a first end-user 516(1) represents a manager to which both of a second end-user 516(2) and a third end-user 516(3) each report. Similarly, multiple other end-users (not individually labeled) are each shown to report to one of the second end-user 516(2) or the third end-user 516(3).

With respect to prescribing personalized attendance importance weights in association with one or more invitees of the preliminary meeting invitation 402, it can be appreciated that in many real-life practical situations a meeting organizer may recognize that that the degree or level of importance with which various invitees attend the meeting can vary greatly. For example, it may be highly important to that a manager with signatory and/or decision-making authority for various actionable items attend a particular meeting and relatively less important that some other end-user such as a lower level employee attend that same meeting. Accordingly, by enabling a meeting organizer to prescribe personalized attendance importance weights in association with individual invitees in the preliminary meeting invitation 402, the calendar system 102 may then utilize these attendance importance weights in identifying suitable timeslot to schedule a calendar event. As a specific example, suppose that the preliminary meeting invitation 402 is generated which indicates that a 1-hour long meeting is being requested within the next upcoming five business days. Further suppose that due to the already busy schedules of the invitees listed within the preliminary meeting invitation 402, only a few timeslots exist where a manager can attend that none of these timeslots are also available to all of the remaining attendees. Accordingly, under these circumstances the calendar system 102 will not be able to identify a 1-hour time slot during which all invitees listed within the preliminary meeting invitation 402 will be free to attend.

Since the ultimately selected timeslot within which the meeting will need to be scheduled will inherently conflict with at least some existing events already on one or more of the invitees' electronic calendars, the calendar system 102 may utilize the prescribed personalized attendance importance weights to prioritize timeslots within which the most important invitees are free to attend. In the illustrated example, due to the first end-user 516(1) having the prescribed attendance weight of 10, the third end-user 516(3) having the prescribed attendance weight of 7, and the Nth end-user 516(N) having the prescribed attendance weight of 3, the calendar system 102 will afford the highest priority to scheduling the one hour meeting within a timeslot that is suitable for the first end-user 516(1) (e.g., in accordance with her electronic calendar 106 and her focus time parameters 118), a relatively lower priority to the third end-user 516(3), and yet still a relatively lower priority to the Nth end-user 516(N). In some implementations, the calendar system 102 will afford the lowest priority to end-users that do not have specific personalized attendance importance weights prescribed within the preliminary meeting invitation for 402 and then stepped up priority to end-users that do have specific personalized attendance with prescribed herein therein.

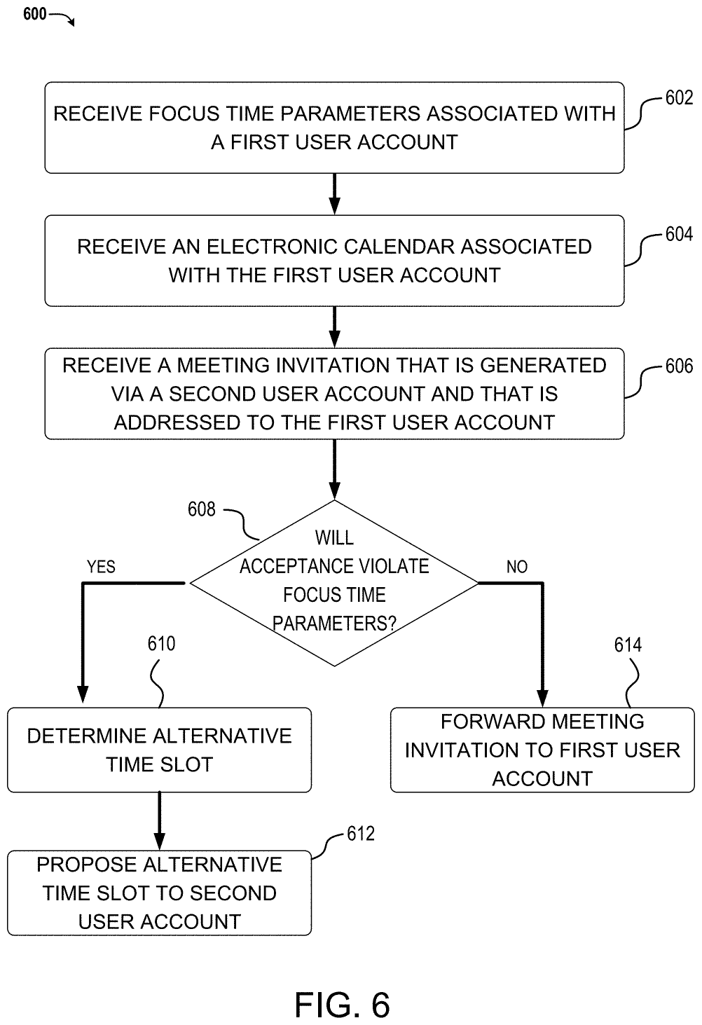

FIG. 6 is a flow diagram of an example method 600 for selecting actions to perform with respect to incoming meeting invitations based on whether acceptance of the incoming meeting invitations would violate focus parameters associated with a user account.

At block 602, the system receives focus time parameters in association with a first user account. As described above, exemplary focus time parameters may define a static scheduled focus time and/or a sliding focus time duration. Furthermore, as also described above, the focus time parameters may indicate flexibility levels in association with the focus time parameters as a whole or, more granularly, varying flexibility levels that uniquely correspond to individual ones of the focus time parameters. For example, a user may customize her focus time parameters to indicate that a static scheduled focus time has a flexibility level of zero meeting that she is completely inflexible with respect to this static scheduled focus time. That is, under no circumstances is this particular individual willing to compromise and accommodate calendar events that would interfere with or violate the static scheduled focus time. Similarly, this same user may customize her focus time parameters to indicate that a sliding focus time duration has a relatively high flexibility such that she is willing to potentially accommodate certain calendar events having certain criteria (e.g., a designation of urgent, a specific user account being included within an invitee list, and so on).

At block 604, the system receives an electronic calendar associated with the first user account. As described above, the electronic calendar may be stored in calendar data store 104 and may define a plurality of scheduled calendar events in association with the first user account.

At block 606, the system receives a meeting invitation that is generated via a second user account and that is addressed to the first user account. The meeting invitation may include a requested timeslot during which a user associated with the second user account is requesting to meet with the user associated with the first user account.

At block 608, the system determines whether or not acceptance of the meeting invitation as initially generated via the second user account will result in a violation of the focus time parameters that are associated with the first user account. For example, the system may determine that the first user would be able to accept the meeting invitation in its original form without having to sacrifice any desired focus time as outlined within the focus time parameters.

Under circumstances in which acceptance of the meeting invitation as originally generated via the second user account will result in a violation of the focus time parameters, the system may proceed to block 610. At block 610, the system automatically determines an alternative timeslot during which the requested meeting could take place without resulting in such a violation of the focus time parameters that correspond to the first user account.

The system may then proceed to block 612. At block 612, the system automatically proposes the alternative timeslot to the second user account via which the meeting invitation was generated.

In some embodiments, the system may determine the alternative timeslot based on identified similarities between characteristics of the meeting invitation that has been received at block 606 and calendar events that already exist within the electronic calendar received at block 604. For example, the system may determine the alternative timeslot in a manner that groups similar meetings together so as to prevent the first user from having to change his or her focus through numerous context switches. As a specific example, the system may analyze content of the meeting invitation and identify that the title of the meeting invitation includes the phrase “1-on-1.” Then, the system may analyze the electronic calendar to identify one or more other existing calendar events having titles that also include the phrase “1-on-1.” Under these specific but nonlimiting circumstances, the system may propose an alternative time for the meeting invitation received at block 606 in a manner that places the proposed time Tim poorly adjacent to one or more other existing calendar events that appear to have a similar context (e.g., the calendar system may attempt to put all of the first user's “1-on-1” meetings on the same day). As another example, the system may determine an alternative timeslot for the meeting invitation based on a determination as to when the first user already has other scheduled calendar events with one or more invitees designated within the meeting invitation. For example, the calendar system may observe that a designated invitee on the meeting invitation received at block 606 is also scheduled to meet with the first user on the day after the meeting invitation initially requests the meeting to be scheduled. Then, responsive to this observation, the calendar system may propose an alternative time and date for the meeting invitation so as to group the newly requested meeting temporally adjacent to one or more other calendar events during which the first user will already be meeting with the invitees.

Furthermore, under circumstances in which multiple different invitees that are designated on the meeting invitation have each defined their own focus time parameters, the calendar system may determine the proposed alternative timeslot based on the focus time parameters for multiple different user accounts.

In some implementations, the system may refrain from forwarding meeting invitations to the first user account based on the determination that acceptance of the meeting invitation would violate the focus time parameters. Alternatively, in other implementations, notwithstanding the determination that acceptance of the meeting invitation would violate focus time parameters, the system may still proceed to forward to meeting invitation to the first user account. In such applications, the system may optionally generate a proposed modification to the meeting invitation and transmit the proposed modification to one or both of the first user account or the second user account.

In the specific implementation shown in FIG. 6, the system is configured to refrain from forwarding the meeting invitation to the first user account in response to determining that acceptance of the meeting invitation would violate the focus time parameters associated with the first user account. Accordingly, the process 600 includes block 614 at which the system forward the meeting invitation to the first user account in response to a determination that acceptance of the meeting in addition would not violate the focus time parameters associated with the first user account.

It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It also should be understood that the illustrated methods can end at any time and need not be performed in their entirety. Some or all operations of the methods, and/or substantially equivalent operations, can be performed by execution of computer-executable instructions included on a computer-storage media, as defined herein. The term “computer-executable instructions,” and variants thereof, as used in the description and claims, is used expansively herein to include routines, applications, application modules, program modules, programs, components, data structures, algorithms, and the like. Computer-executable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system (e.g., server resources allocated to the calendar system 102) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

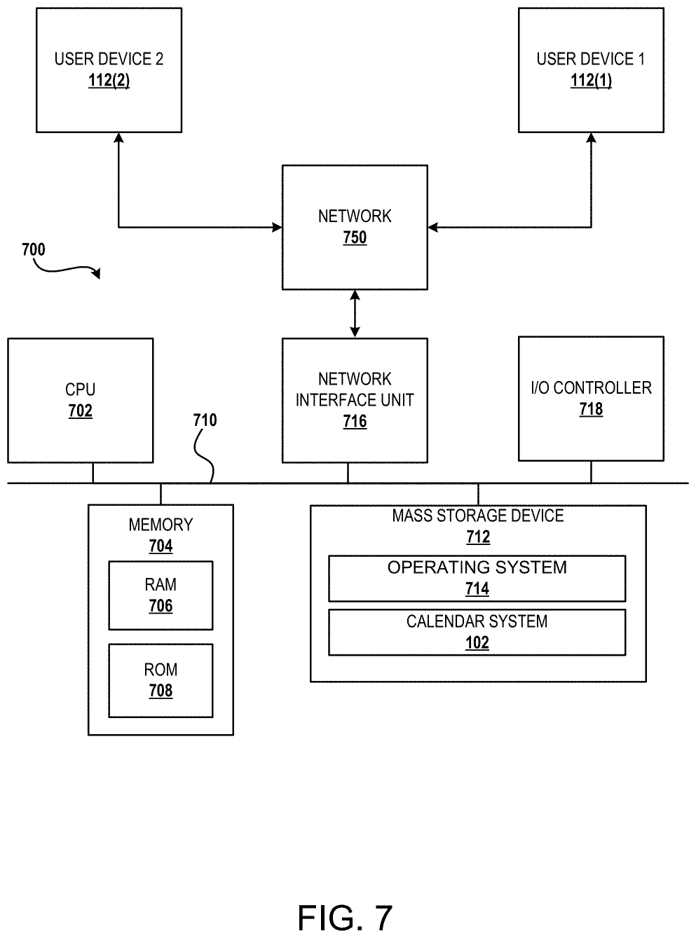

FIG. 7 shows additional details of an example computer architecture 700 for a computer capable of executing the query scoping service 102 and/or any program components thereof as described herein. Thus, the computer architecture 700 illustrated in FIG. 7 illustrates an architecture for a server computer, or network of server computers, or any other types of computing devices suitable for implementing the functionality described herein. The computer architecture 700 may be utilized to execute any aspects of the software components presented herein.

The computer architecture 700 illustrated in FIG. 7 includes a central processing unit 702 (“CPU”), a system memory 704, including a random-access memory 706 (“RAM”) and a read-only memory (“ROM”) 708, and a system bus 710 that couples the memory 704 to the CPU 702. A basic input/output system containing the basic routines that help to transfer information between elements within the computer architecture 700, such as during startup, is stored in the ROM 708. The computer architecture 700 further includes a mass storage device 712 for storing an operating system 714, other data, and one or more application programs. The mass storage device 712 may further include one or more of the calendar system 102.

The mass storage device 712 is connected to the CPU 702 through a mass storage controller (not shown) connected to the bus 710. The mass storage device 712 and its associated computer-readable media provide non-volatile storage for the computer architecture 700. Although the description of computer-readable media contained herein refers to a mass storage device, such as a solid-state drive, a hard disk or CD-ROM drive, it should be appreciated by those skilled in the art that computer-readable media can be any available computer storage media or communication media that can be accessed by the computer architecture 700.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 700. For purposes of the claims, the phrase “computer storage medium,” “computer-readable storage medium” and variations thereof, does not include waves, signals, and/or other transitory and/or intangible communication media, per se.

According to various techniques, the computer architecture 700 may operate in a networked environment using logical connections to remote computers through a network 650 and/or another network (not shown). The computer architecture 700 may connect to the network 650 through a network interface unit 716 connected to the bus 710. It should be appreciated that the network interface unit 716 also may be utilized to connect to other types of networks and remote computer systems. The computer architecture 700 also may include an input/output controller 718 for receiving and processing input from a number of other devices, including a keyboard, mouse, or electronic stylus (not shown in FIG. 7). Similarly, the input/output controller 718 may provide output to a display screen, a printer, or other type of output device (also not shown in FIG. 7). It should also be appreciated that via a connection to the network 750 through a network interface unit 716, the computing architecture may enable the Calendar System 102 to communicate with the user devices 112.

It should be appreciated that the software components described herein may, when loaded into the CPU 702 and executed, transform the CPU 702 and the overall computer architecture 700 from a general-purpose computing system into a special-purpose computing system customized to facilitate the functionality presented herein. The CPU 702 may be constructed from any number of transistors or other discrete circuit elements, which may individually or collectively assume any number of states. More specifically, the CPU 702 may operate as a finite-state machine, in response to executable instructions contained within the software modules disclosed herein. These computer-executable instructions may transform the CPU 702 by specifying how the CPU 702 transitions between states, thereby transforming the transistors or other discrete hardware elements constituting the CPU 702.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 700 in order to store and execute the software components presented herein. It also should be appreciated that the computer architecture 700 may include other types of computing devices, including hand-held computers, embedded computer systems, personal digital assistants, and other types of computing devices known to those skilled in the art. It is also contemplated that the computer architecture 700 may not include all of the components shown in FIG. 7, may include other components that are not explicitly shown in FIG. 7, or may utilize an architecture completely different than that shown in FIG. 7.

Accordingly, generic references to attributes within the foregoing description and in the appended claims may refer to user attributes, or device attributes, or both. Furthermore, generic references to accounts within the foregoing description and in the appended claims may refer to user accounts, device accounts, or both. Furthermore, generic references to a directory within the foregoing description and in the appended claims may refer to a user directory, a device directory, or both.

### EXAMPLE CLAUSES

The disclosure presented herein may be considered in view of the following clauses.

Example 1. An electronic calendar system comprising: one or more processing units; and a computer-readable storage medium having computer-executable instructions stored thereupon, which, when executed by the one or more processing units, cause the one or more processing units to: receive focus time parameters that are defined in association with a first user account; receive, from a second user account, a meeting invitation that is configured to facilitate generation of a calendar event during a requested time slot within an electronic calendar corresponding to the first user account; determine whether adding the calendar event to the electronic calendar during the requested time slot will violate of the focus time parameters that are defined in association with the first user account; and responsive to determining that adding the calendar event to the electronic calendar during the requested time slot will violate the focus time parameters, determine a proposed time slot during which the calendar event can be added to the electronic calendar corresponding to the first user account without violating the focus time parameters that are defined in association with the first user account.

Example 2. The calendar system of Example 1, wherein the meeting invitation is a recurring meeting invitation that is configured to facilitate generation of a series of calendar events during the requested time slot at a requested recurrence frequency that will violate the focus time parameters, and wherein determining the proposed time slot includes determining a proposed recurrence frequency modification for generating the series of calendar events in the electronic calendar without violating the focus time parameters.

Example 3. The electronic calendar system of Example 2, wherein determining the proposed time slot includes determining a proposed duration modification for adjusting a meeting duration of at least some individual calendar events of the series of calendar events.

Example 4. The electronic calendar system of Example 1, wherein the focus time parameters include a flexibility level associated with at least one of a static scheduled focus time or a sliding preferred focus duration, and wherein determining whether adding the calendar event to the electronic calendar during the requested time slot will violate the focus time parameters is based on the flexibility level and at least one of: a meeting importance level included within the meeting invitation, or a meeting organizer of the meeting invitation.

Example 5. The electronic calendar system of Example 1, wherein the computer-executable instructions further cause the one or more processing units to: responsive to determining that adding the calendar event to the electronic calendar during the requested time slot will violate the focus time parameters, transmit an automatic declination, of the meeting invitation, to the second user account, wherein the automatic declination includes an indication of the proposed time slot.

Example 6. The electronic calendar system of Example 1, wherein the computer-executable instructions further cause the one or more processing units to: responsive to determining that adding the calendar event to the electronic calendar during the requested time slot will not violate the focus time parameters, transmit the meeting invitation to the first user account; and responsive to determining that adding the calendar event to the electronic calendar during the requested time slot will violate the focus time parameters, refrain from transmitting the meeting invitation to the first user account.

Example 7. The electronic calendar system of Example 1, wherein the computer-executable instructions further cause the one or more processing units to: responsive to determining that adding the calendar event to the electronic calendar during the requested time slot will violate the focus time parameters defined in association with a first user account, transmit an indication of the proposed time slot to the second user account; receive, from the second user account, a proposal acceptance associated with the proposed time slot; and responsive to receiving the proposal acceptance, transmitting an updated meeting invitation, to the first user account, that is configured to facilitate generation of the calendar event during the proposed time slot within the electronic calendar.

Example 8. A computer-implemented method, comprising: receiving focus time parameters that are defined in association with a first user account, wherein the focus time parameters define at least one of a static scheduled focus time or a sliding preferred focus duration; receiving, from a second user account, a recurring meeting invitation that is configured to facilitate generation of a series of calendar events, within an electronic calendar corresponding to the first user account, during a requested time slot at a requested recurrence frequency; determining that adding the series of calendar events to the electronic calendar during the requested time slot at the requested recurrence frequency will violate of the focus time parameters that are defined in association with the first user account; responsive to determining that adding the series of calendar events to the electronic calendar during the requested time slot at the requested recurrence frequency will violate of the focus time parameters, determining a proposed modification for the recurring meeting invitation; and generating, based on the proposed modification, an updated recurring meeting invitation to facilitate generation of the series of calendar events, within the electronic calendar corresponding to the first user account, without violating the focus time parameters that are defined in association with the first user account.

Example 9. The computer-implemented method of Example 8, wherein the proposed modification includes a proposed frequency modification.

Example 10. The computer-implemented method of Example 8, wherein the proposed modification includes a proposed duration modification.

Example 11. The computer-implemented method of Example 8, wherein the proposed modification includes: a proposed frequency, for the series of calendar events, that is different than a requested frequency for the series of calendar events that is indicated within the recurring meeting invitation, and a proposed duration, for individual calendar events of the series of calendar events, that is different than a requested duration that is indicated within the recurring meeting invitation.

Example 10. The computer-implemented method of Example 8, wherein the proposed modification includes a proposed duration modification.

Example 12. The computer-implemented method of Example 8, further comprising: automatically responding to the recurring meeting invitation by transmitting the proposed modification to the second user account; and responsive to receiving a proposal acceptance in association with the proposed modification, transmitting an updated recurring meeting invitation to the first user account.

Example 13. The computer-implemented method of Example 8, wherein the determining that adding the series of calendar events to the electronic calendar during the requested time slot at the requested recurrence frequency will violate of the focus time parameters is based on calendar data that corresponds to the first user account.

Example 14. A system comprising: one or more processing units; and a computer-readable storage medium having computer-executable instructions stored thereupon, which, when executed by the one or more processing units, cause the one or more processing units to: receive a preliminary meeting invitation that indicates at least a requested meeting duration and that designates a plurality of user accounts as invitees: receive calendar data corresponding to the plurality of user accounts; determine a proposed time slot based on the requested meeting duration and the calendar data; and transmit an auto-generated meeting invitation, that corresponds to the preliminary meeting invitation, to the plurality of user accounts.

Example 15. The system of Example 14, wherein the preliminary meeting invitation further indicates a requested meeting date range, and wherein the proposed time slot falls within the requested meeting date range.

Example 16. The system of Example 14, wherein determining the proposed time slot is further based on genericized calendar data that is included within the preliminary meeting invitation.

Example 17. The system of Example 14, wherein determining the proposed time slot is further based on one or more personalized attendance importance weights that are included within the preliminary meeting invitation.

Example 18. The system of Example 17, wherein the one or more personalized attendance importance weights include at least a first personalized attendance importance weight, associated with a first user account, and a second personalized attendance importance weight that is associated with a second user account and that is less than the first personalized attendance importance weight, and wherein the proposed time slot conflicts with a calendar event scheduled for the second user account and does not conflict with any calendar events for the first user account.

Example 19. The system of Example 14, wherein the computer-executable instructions further cause the one or more processing units to: receive focus time parameters that are defined in association with one or more of the plurality of user accounts, wherein the focus time parameters define at least one of a static scheduled focus time or a sliding preferred focus duration.

Example 20. The system of Example 19, wherein determining the proposed time slot is further based on the focus time parameters.

### CONCLUSION

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. An electronic calendar system comprising:
one or more processing units; and
a computer-readable storage medium having computer-executable instructions stored thereupon, which, when executed by the one or more processing units, cause the one or more processing units to:
receive focus time parameters that are defined in association with a first user account;
generate a user-specific calendar scheduling model for the first user account based on a plurality of previous meeting invitations and the focus time parameters;
receive, from a second user account, a meeting invitation that is configured to facilitate generation of a calendar event during a requested time slot within an electronic calendar corresponding to the first user account;
determine whether adding the calendar event to the electronic calendar during the requested time slot violates the focus time parameters that are defined in association with the first user account; and
responsive to determining that adding the calendar event to the electronic calendar during the requested time slot violates the focus time parameters, determine, using the user-specific calendar scheduling model, a proposed time slot during which the calendar event can be added to the electronic calendar corresponding to the first user account without violating the focus time parameters that are defined in association with the first user account.

2. The electronic calendar system of claim 1, wherein the meeting invitation is a recurring meeting invitation that is configured to facilitate generation of a series of calendar events during the requested time slot at a requested recurrence frequency that violates the focus time parameters, and wherein determining the proposed time slot includes determining a proposed recurrence frequency modification for generating the series of calendar events in the electronic calendar without violating the focus time parameters.

3. The electronic calendar system of claim 2, wherein determining the proposed time slot includes determining a proposed duration modification for adjusting a meeting duration of at least some individual calendar events of the series of calendar events.

4. The electronic calendar system of claim 1, wherein the focus time parameters include a flexibility level associated with at least one of a static scheduled focus time or a sliding preferred focus duration, and wherein determining whether adding the calendar event to the electronic calendar during the requested time slot violates the focus time parameters is based on the flexibility level and at least one of:
a meeting importance level included within the meeting invitation, or
a meeting organizer of the meeting invitation.

5. The electronic calendar system of claim 1, wherein the computer-executable instructions further cause the one or more processing units to:
responsive to determining that adding the calendar event to the electronic calendar during the requested time slot violates the focus time parameters, transmit an automatic declination, of the meeting invitation, to the second user account, wherein the automatic declination includes an indication of the proposed time slot.

6. The electronic calendar system of claim 1, wherein the computer-executable instructions further cause the one or more processing units to:
responsive to determining that adding the calendar event to the electronic calendar during the requested time slot does not violate the focus time parameters, transmit the meeting invitation to the first user account; and
responsive to determining that adding the calendar event to the electronic calendar during the requested time slot violates the focus time parameters, refrain from transmitting the meeting invitation to the first user account.

7. The electronic calendar system of claim 1, wherein the computer-executable instructions further cause the one or more processing units to:
responsive to determining that adding the calendar event to the electronic calendar during the requested time slot violates the focus time parameters defined in association with a first user account, transmit an indication of the proposed time slot to the second user account;
receive, from the second user account, a proposal acceptance associated with the proposed time slot; and
responsive to receiving the proposal acceptance, transmit an updated meeting invitation, to the first user account, that is configured to facilitate generation of the calendar event during the proposed time slot within the electronic calendar.

8. A computer-implemented method, comprising:
receiving focus time parameters that are defined in association with a first user account, wherein the focus time parameters define a static scheduled focus time;
receiving, from a second user account, a recurring meeting invitation that is configured to facilitate generation of a series of calendar events, within an electronic calendar corresponding to the first user account, during a requested time slot at a requested recurrence frequency;
determining that adding the series of calendar events to the electronic calendar during the requested time slot at the requested recurrence frequency will violate of violates the focus time parameters that are defined in association with the first user account;
responsive to determining that adding the series of calendar events to the electronic calendar during the requested time slot at the requested recurrence frequency violates the focus time parameters, determining a proposed modification for the recurring meeting invitation; and
generating, based on the proposed modification, an updated recurring meeting invitation to facilitate generation of the series of calendar events, within the electronic calendar corresponding to the first user account, without violating the focus time parameters that are defined in association with the first user account.

9. The computer-implemented method of claim 8, wherein the proposed modification includes a proposed frequency modification.

10. The computer-implemented method of claim 8, wherein the proposed modification includes a proposed duration modification.

11. The computer-implemented method of claim 8, wherein the proposed modification includes:
a proposed frequency, for the series of calendar events, that is different than a requested frequency for the series of calendar events that is indicated within the recurring meeting invitation, and
a proposed duration, for individual calendar events of the series of calendar events, that is different than a requested duration that is indicated within the recurring meeting invitation.

12. The computer-implemented method of claim 8, further comprising:
automatically responding to the recurring meeting invitation by transmitting the proposed modification to the second user account; and
responsive to receiving a proposal acceptance in association with the proposed modification, transmitting an updated recurring meeting invitation to the first user account.

13. The computer-implemented method of claim 8, wherein the determining that adding the series of calendar events to the electronic calendar during the requested time slot at the requested recurrence frequency violates of the focus time parameters is based on calendar data that corresponds to the first user account.

14-20. (canceled)

21. The electronic calendar system of claim 1, wherein the user-specific calendar scheduling model determines the proposed time slot based on meeting times of the plurality of previous meeting invitations and one or more characteristic similarities between one or more user accounts associated with the plurality of previous meeting invitations and the second user account.

22. The computer-implemented method of claim 8, wherein the static scheduled focus time defined by the focus time parameters cannot be violated to accommodate the recurring meeting invitation.

23. A computer-implemented method, comprising:
receiving focus time parameters that are defined in association with a first user account;
generating, by one or more processing units, a user-specific calendar scheduling model for the first user account based on a plurality of previous meeting invitations and the focus time parameters;
receiving, from a second user account, a meeting invitation that is configured to facilitate generation of a calendar event during a requested time slot within an electronic calendar corresponding to the first user account;
determining whether adding the calendar event to the electronic calendar during the requested time slot violates the focus time parameters that are defined in association with the first user account; and
responsive to determining that adding the calendar event to the electronic calendar during the requested time slot violates the focus time parameters, determining, using the user-specific calendar scheduling model, a proposed time slot during which the calendar event can be added to the electronic calendar corresponding to the first user account without violating the focus time parameters that are defined in association with the first user account.

24. The computer-implemented method of claim 23, wherein the focus time parameters include a flexibility level associated with at least one of a static scheduled focus time or a sliding preferred focus duration, and wherein determining whether adding the calendar event to the electronic calendar during the requested time slot violates the focus time parameters is based on the flexibility level and at least one of:
a meeting importance level included within the meeting invitation, or
a meeting organizer of the meeting invitation.

25. The computer-implemented method of claim 23, further comprising:
responsive to determining that adding the calendar event to the electronic calendar during the requested time slot violates the focus time parameters, transmitting an automatic declination, of the meeting invitation, to the second user account, wherein the automatic declination includes an indication of the proposed time slot.

26. The computer-implemented method of claim 23, wherein the meeting invitation is a recurring meeting invitation that is configured to facilitate generation of a series of calendar events during the requested time slot at a requested recurrence frequency that violate the focus time parameters, and wherein determining the proposed time slot includes determining a proposed recurrence frequency modification for generating the series of calendar events in the electronic calendar without violating the focus time parameters.

27. The computer-implemented method of claim 26, wherein the user-specific calendar scheduling model determines the proposed time slot based on meeting times of the plurality of previous meeting invitations and one or more characteristic similarities between one or more user accounts associated with the plurality of previous meeting invitations and the second user account.
